(19) United States
(12) Patent Application Publication
(10) Pub. No.: US 2024/0361742 A1
(43) Pub. Date: Oct. 31, 2024

(54) ARTIFICIALLY INTELLIGENT CONTROL SYSTEM AGENT

(71) Applicant: Agbotic Inc., Sackets Harbor, NY (US)

(72) Inventor: John Paul Gaus, Watertown, NY (US)

(73) Assignee: Agbotic Inc., Sackets Harbor, NY (US)

(21) Appl. No.: 18/645,984

(22) Filed: Apr. 25, 2024

Related U.S. Application Data
(60) Provisional application No. 63/498,108, filed on Apr. 25, 2023.

(51) Int. Cl. G05B 19/05

(52) U.S. Cl. CPC G05B 19/05

(57) ABSTRACT

A computer-implemented method including querying, from data sources including a data historian associated with performance of an automated environment controlled by one or more programmable logic controllers (PLCs), data for the automated environment controlled by the one or more PLCs. The method also can include validating and error-correcting the data, and generating multiple potential solution sets based on the data and multiple machine-learning models. The method additionally can include assessing the multiple potential solution sets to select one or more solution sets. The method further can include outputting at least one solution set of the one or more solution sets to cause (i) set points and process inputs of the one or more PLCs to be automatically updated based at least in part on the at least one solution set, and (ii) physical devices of the automated environment controlled by the one or more PLCs to alter behavior of the automated environment. Other embodiments are described.

### CROSS-REFERENCE TO RELATED APPLICATION

This application claims the benefit of U.S. Provisional Application No. 63/498,108, filed Apr. 25, 2023. U.S. Provisional Application No. 63/498,108 is incorporated herein by reference in its entirety.

### TECHNICAL FIELD

This disclosure relates generally to an artificially intelligent control system agent.

### BACKGROUND

A programmable logic controller (PLC) or programmable controller is an industrial computer adapted for the control of manufacturing processes, such as assembly lines, machines, robotic devices, or any activity that involves automation, reliability, ease of programming, and/or process fault diagnosis in process or production settings. These PLC systems essentially receive data from a variety of sensors and automate via if/then logic and control system feedback loops how a facility and/or its operators can turn machines on, turn machines off, speed machines up, slow machines down, open and close devices, etc. PLCs may also involve safety, alarm, and reporting features. Many of these PLC systems also log data for analysis.

Conventionally, PLCs have a Human Machine Interface (HMI) component. The HMI allow users to interface with the PLC typically via touch screen in the factory or plant or via a computer workstation. Users often interface with various PLC application screens to change system set points in the PLC. Such set points can include motor speeds, fluid pumping pressures, frequency of valve operations, valve opening and closing ratios, temperatures and/or pressures of fluid flow, temperatures of ovens, target temperatures for various process steps, fuel injection rates for combustion systems, light levels in a greenhouse, etc. PLC set points drive any selected, controlled output in a physical plant such as power plant fuel efficiency, power plant emissions, chemical plant output, conveyor belt speeds, greenhouse yield, cracker crispiness in a cracker manufacturing plant or any identifiable and measurable characteristic of the results of any industrial plant or commercial processing or manufacturing process. Examples of brand name PLCs include Siemens, Allen Bradley, ABB, or Schneider Electric, or any similar or competing control system deployed into any facility such as a power plant, or chemical manufacturing facility, or water treatment plant, or greenhouse, or food or widget manufacturing plant.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for an artificially intelligent control system agent, according to an embodiment;

FIG. 4 illustrates a flow chart for a method 400 of implementing an artificially intelligent control system agent, according to an embodiment;

FIG. 5 illustrates a graph showing improvements in yield for microgreens through the application of data analytics;

FIG. 6 illustrates a heatmap of variable correlations with yield from analysis by a statistical model applied against this data; and

FIG. 7 shows an example of a decision tree generated by a Random Forest machine learning model for yield prediction using this greenhouse data, to determine which input levels optimize the yield in this environment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, or ten minutes.

### DESCRIPTION OF EXAMPLES OF EMBODIMENTS

Various embodiments include a computer-implemented method including querying, from data sources including a data historian associated with performance of an automated environment controlled by one or more programmable logic controllers (PLCs), data for the automated environment controlled by the one or more PLCs. The method also can include generating multiple potential solution sets based on the data and multiple machine-learning models. The method additionally can include assessing the multiple potential solution sets to select one or more solution sets. The method further can include outputting at least one solution set of the one or more solution sets to cause (i) set points of the one or more PLCs to be automatically updated based at least in part on the at least one solution set, and (ii) physical devices of the automated environment controlled by the one or more PLCs to alter physical behavior of the automated environment.

A number of embodiments can include a system including one or more processors and one or more non-transitory computer-readable media storing computing instructions that, when executed on the one or more processors, cause the one or more processors to perform operations including querying, from a data historian and/or other data sources associated with one or more programmable logic controllers (PLCs), data for an automated environment controlled by the one or more PLCs. The operations can include validating and completing the queried data using data wrangling techniques to make the data clean, complete, and formatted for advanced data analytics. The operations also can include generating, via multiple machine learning models, multiple potential solution sets representing improved PLC system set points and/or process inputs, based on the data and multiple machine-learning models. The operations additionally can include assessing the multiple potential solution sets to select one or more solution sets to be used for updating PLC settings and process inputs. The operations further can include outputting at least one solution set of the one or more solution sets to cause (i) set points of the one or more PLCs to be automatically updated based at least in part on the at least one solution set, and (ii) physical devices of the automated environment controlled by the one or more PLCs to alter physical behavior of the automated environment.

A number of embodiments can include one or more non-transitory computer-readable media including computing instructions that, when executed on one or more processors, cause the one or more processors to perform operations including querying, from a data historian associated with one or more programmable logic controllers (PLCs), data for an automated environment controlled by the one or more PLCs. The operations also can include generating multiple potential solution sets based on the data and multiple machine-learning models. The operations additionally can include assessing the multiple potential solution sets to select one or more solution sets. The operations further can include outputting at least one solution set of the one or more solution sets to cause (i) set points of the one or more PLCs to be automatically updated, without the use of an HMI, based at least in part on the at least one solution set, and (ii) physical devices of the automated environment controlled by the one or more PLCs to alter physical behavior of the automated environment.

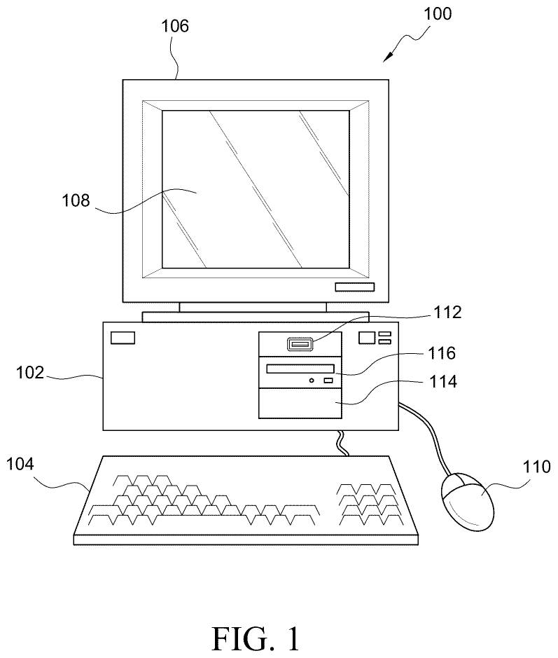

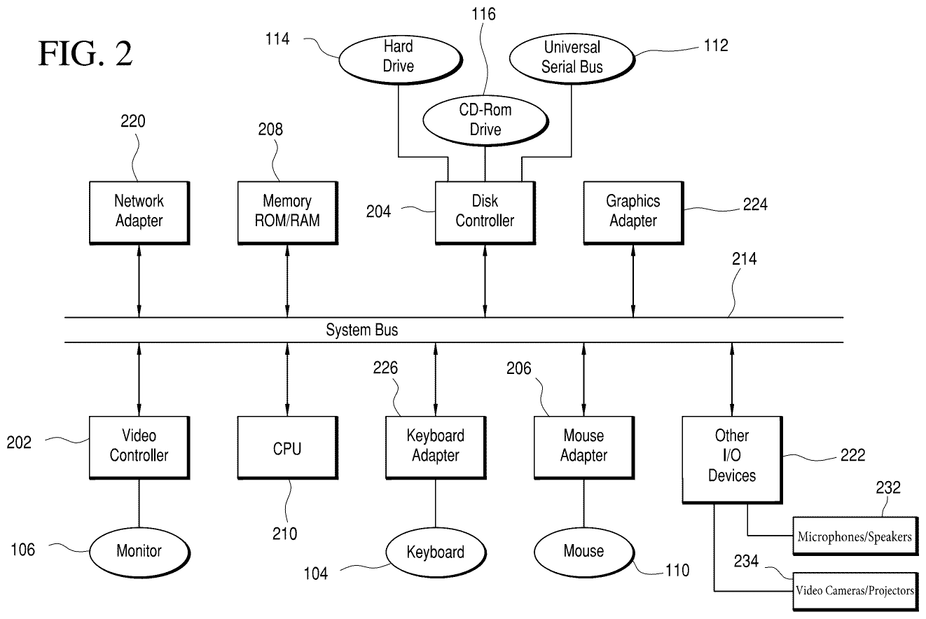

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. For example, other I/O devices 222 can include microphones and speakers 232, video cameras and projectors 234, and/or other suitable I/O devices. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

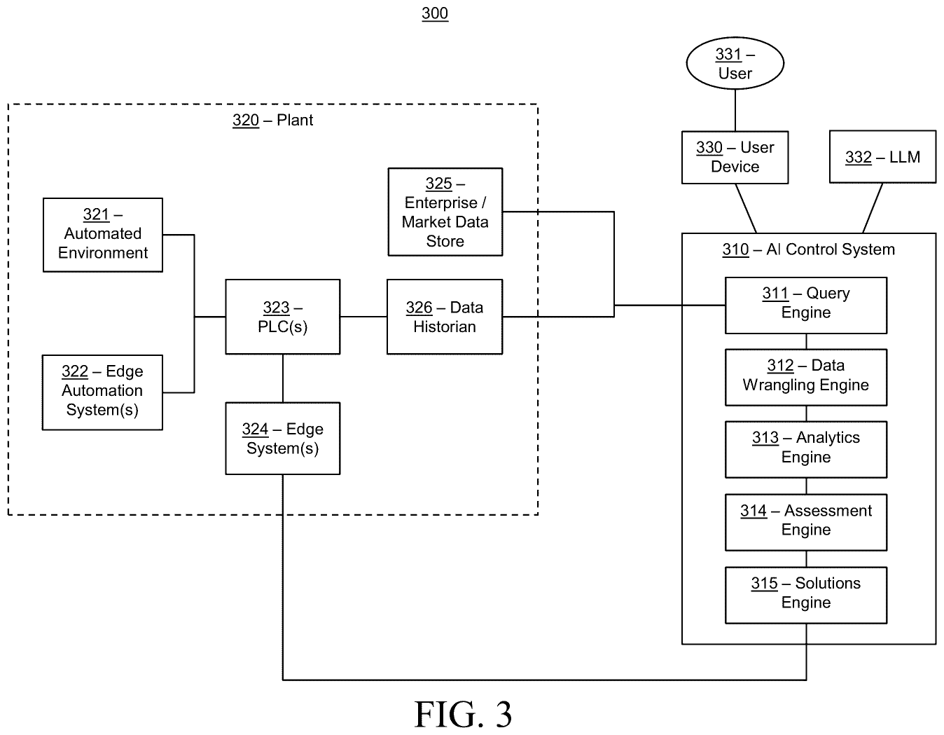

Turning ahead in the drawings, FIG. 3 illustrates a block diagram of a system 300 that can be employed for an artificially intelligent control system agent, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an artificial intelligence (AI) control system 310 and, in some embodiments, can include a plant 320. Plant 320 can be a factory, plant, greenhouse, building, powerplant, water treatment plant, bakery, widget manufacturing, or other type of facility that includes an automated environment 321, which can be automated using one or more PLCs (e.g., PLCs 323).

Automated environment 321 can be a power plant, a chemical plant, a greenhouse, a manufacturing plant (e.g., manufacturing widgets, food, etc.), a water treatment plant, building, or another suitable type of automated environment. PLCs 323 can be PLCs and/or process automation controllers (PACs), such as those made by Siemens, Allen Bradly, ABB, Schneider Electric, etc. PLCs 323 can include control software with set points. For example, such set points can include motor speeds, fluid pumping pressures, frequency of valve operations, valve opening and closing ratios, temperatures and/or pressures of fluid flow, fan speeds, temperatures of ovens, target temperatures for various process steps, fuel injection rates for combustion systems, light levels in a greenhouse, etc.

In many embodiments, plant 320 can include one or more edge automation systems 322, which can provide an interface between (i) PLCs 323 and (ii) sensors and/or physical automation (e.g., robotics) devices. For example, sensors at plant 320 that is a greenhouse can collect data inputs, such as quantum light, soil temperature and water levels, air temperature and water levels, weather, energy usage, water usage, etc. Automated operation of the greenhouse can be driven by physical automation devices, such as robotic gantry, motors, fans, pumps, lights, doors, etc., and in many embodiments, these devices can be driven by set points of PLCs 323, which in turn can modify the performance of machines that charge soil nutrients, seed the greenhouse, till soil, cultivate crops, and/or harvest crops, to affect crop yields. Examples of edge automation systems 322 in an automated greenhouse or other facility with automated systems can be one or more of the following examples of edge computing and automation systems:
Edge 1: LiDAR scanning and assessments.
Edge 2: Infrared moisture monitoring and management.
Edge 3: Infrared space heating and cooling monitoring and management.
Edge 4: Vision/pests detection and control of response measures.
Edge 5: Vapor pressure deficit monitoring and management.
Edge 6: Soil probe for chemistry, temperatures and moisture and associated analysis and controls.
Edge 7: Weather monitoring and proactive facility automation adjustments.
Edge X: Any edge computing or software application not suitable for running on a primary facility PLC, but meant to perform a function that can inform or enhance the performance of one or more PLCs.

In some embodiments, plant 320 can include one or more edge systems 324, can be a system capable of communicating with PLCs 323. In some embodiments, edge system 324 can be a buffer capable of writing the set points to PLCs 323, and/or an AI system. For example, edge system 324 can be Factory Talk for Allen-Bradley, Step 7 for Siemens, or Siemens Edge computing devices, which can flexibly work with multiple different types of systems. In other embodiments, edge system 324 is not used, and the set points are written to PLCs 323 via network connections without edge system 324.

In several embodiments, plant 320 can include an enterprise/market data store 325, which can include enterprise and/or market data store, such as a custom ERP (enterprise resource planning) component, which can be built on a suitable database, such as any file allocation table, tabular or SQL data format, or Google Sheets, etc., and which can include data that is auto-populated from other business systems, internet sources, and/or manually entered from information measured at plant 320 (e.g., laboratory tests on soil, weather databases, fuel prices, commodity exchanges, etc.). Enterprise/market data store 325 can include any structured data source, and in many embodiments can be SQL-based or time-series based. Enterprise/market data store 325 can and include off-site/cloud sources such as Microsoft Azure, such as when clients are storing data in cloud-based systems. Any structured data format query tool of the many that work with SQL, sheets, .csv, or any tabular or time-series data file can be used for enterprise/market data store 325.

In many embodiments, plant 320 can include a data historian 326, which can be a conventional data historian associated with PLCs 323. Data historian 326 can be include one or more time-series databases that log data (e.g., high volumes of time series data) from sensors and/or PLC 323 in plant 320. In some embodiments, data historian 326 can track setpoints, plant data, and/or process/functional results of automated environment 321 For example, data historian 326 can be the AVEVA PI, Canary, or another suitable time-series data file source.

In many embodiments, AI control system 310 can be used to exchange information with various components of plant 320, automatically and/or iteratively, such as to query, format, and/or analyze performance data; predict improved set points for PLCs 323; automatically change PLC set points for PLCs 323; and/or continually improve the PLC function for PLCs 323. In many embodiments, AI control system can include one or more engines or systems, such as a query engine 311, a data wrangling engine 312, an analytics engine 313, an assessment engine 314, a solutions engine 315, and/or other suitable engines. In many embodiments, such engines of AI control system 310 can be modules of computing instructions (e.g., software modules) stored at non-transitory computer readable media that operate on one or more processors. In some embodiments, various engines of AI control system 310 can be implemented in hardware. These interacting engines can exchange data in various formats such as CSV, ODBC, Pickle, Feather, and/or other suitable formats. Additional details regarding the engines of AI control system 310 are described below.

In many embodiments, AI control system 310 and/or the various engines thereof each can be a computer system, such as computer system 100 (FIG. 1), as described above, and can be a single computer, a single server, or a cluster or collection of computers or servers, or a cloud of computers or servers. In another embodiment, a single computer system can host AI control system 310 and its engines. In some embodiments, one or more of the components of plant 320 can be contained within AI control system 310, while in other embodiments, such components can be separate from AI control system 310. For example, in some embodiments, data historian 326 can be part of AI control system 310.

Generally, therefore, system 300 and/or AI control system 310 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, AI control system 310 can be in data communication, such as through a network (not shown) with one or more user devices 330. User device 330 can be part of system 300 or external to system 300. The network can be the Internet or another suitable network. In some embodiments, user device 330 can be used by users 331. In these or other embodiments, the use (e.g., operator and/or administrator) of AI control system 310 can manage AI control system 310, the processor(s) of AI control system 310, and/or the memory storage unit(s) of AI control system 310 using the input device(s) and/or display device(s) of AI control system 310. In some embodiments, AI control system 310 and/or the engines thereof can be used in various different type of plants (e.g., 320) and automated environments (e.g., 321), such as plug-and-play to enable a learning model for software-defined control in various different environments. In some embodiments, users (e.g., 331) and/or one or more large language models (LLM) 332 can be used to configure, manage, and/or define functions of one or more of the engines (e.g., 311-315) of AI control system 310. In some embodiments, LLM 332 can be a GPT (Generative Pretrained Transformer), such as a GPT created by OpenAI, which can be customized and/or trained.

In many embodiments, AI control system 310 can include one or more input devices (e.g., one or more keyboards, one or more keypads, one or more pointing devices such as a computer mouse or computer mice, one or more touchscreen displays, one or more microphones, cameras, projectors, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to AI control system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of AI control system 310. In a similar manner, the processors and/or the non-transitory computer-readable media can be local and/or remote to each other.

Meanwhile, in many embodiments, AI control system 310 also can be configured to communicate with one or more databases (e.g., enterprise/market data store 325, data historian 326, and/or other suitable databases). The one or more databases can store inputs, constraints, data structures, and/or outputs used in AI control, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, AI control system 310 and/or the one or more databases can be implemented using any suitable manner of wired and/or wireless communication. Accordingly, AI control system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In a number of embodiments, query engine 311 can query enterprise/market data store 325 and/or data historian 326 to obtain information from such data stores. In many embodiments, query engine can be configurable, and can make multiple forms of queries against enterprise/market data store 325 and/or data historian 326 to obtain multiple forms (e.g., versions, presentation) of the data for analysis. Multiple forms of querying the data can be used, as the same method of data analysis performed against the same data set queried and presented in different forms can yield different results. For example, a Gaussian regression machine learning optimization for set points based on real-time data queried and formatted in one-hour averages vs. the same Gaussian regression optimization of the same real-time data queried and formatted in 4-hour step functions to optimize the set points may return different results. In some embodiments, forms of the queries can be one or more of real-time, hourly averages, multiple hour averages, daily averages, batch process, and/or another suitable form. In some embodiments, a Python library called Pandas or similar software can be used to perform the queries, but query engine 311 can use another structured data and/or SQL query tool, and the data can be obtained in various formats, such as HDF (hierarchical data format), etc.

In some embodiments, the queries can be custom written in query engine 311. In other embodiments, the queries can be generated through a LLM (e.g., 332), such as a GPT, which can greatly accelerates the process. For example, tables of inputs to output (e.g., crop yield) can be constructed, but can use any output measurement, such as the Brix level of plant tissues. The queries can include environmental conditions in the greenhouse as measured by sensors and stored in data historian 326, soil chemistry from laboratory tests stored in enterprise/market data store 325, and/or machine settings stored in PLCs 323. LLM 332 can be prompted with text after establishing permissions to the database (e.g., Google sheet), and process (e.g., a script) can load the contents of the specified database (e.g., Google Sheet) into a Pandas DataFrame for further processing. DataFrames are tables, and Python offers a wide range of methods and functionalities for data manipulation tasks, including filtering, sorting, group-by operations, merging/joining datasets, handling time-series data, and/or other suitable operations. In some embodiments, LLM 332 can be voice-enabled. LLM 332 can be part of, or external to, AI control system 310. For example, LLM 332 can be voice-enabled through one or more I/O devices 222, such as microphone 232 (FIG. 2), video camera 234 (FIG. 2), etc. Interacting with LLM 332 can be via keyboard text prompt, and/or any form of input (e.g., digital, video, audio) in the prompt or via spoken voice using a microphone and hearing responses from a speaker (e.g., 232 (FIG. 2)), video camera 234 (FIG. 2), or a combination of any of the foregoing. In many embodiments, devices, software, processes, and factory operations can be AI-interpreted voice controlled and the techniques described herein can work with such systems to optimize automation performance in any setting, but does not require the presence of AI interpreted voice control to do so.

In some embodiments, data wrangling engine 312 can validate the format and/or completeness of the data received by query engine 311, and/or convert the data to a reliable and/or complete form. For example, data wrangling engine 312 can use Pandas, OpenRefine, Trifacta Wrangler, or another suitable data wrangling tool with similar libraries/functions. In some embodiments, data wrangling engine 312 can validate data type, structure, and/or completeness, and in some embodiments, can fill in null or invalid cells, and/or ensure that all data in a particular column of a table has the same format. For example, if there is missing data from data historian 326, data wrangling engine 312 can extrapolate the time-series data function and fill in those missing portions. As another example, if there is a null cell, data wrangling engine can fill in the median, mean, or another calculated value from the same column in the table of the data. As another example, if a column in a table has mixed data types, such as integers and floating-point decimals, the wrangling engine can convert all of the data in the column to one type or the other. These approaches for wrangling the data can be custom-written or generated through an LLM (e.g., 332), which can greatly accelerate the process.

An example of using a GPT to generate code that can perform data wrangling can involve using a text prompt to the GPT, such as the following prompt:
“I have a table in a file named cropyields.csv comprised of twenty columns of inputs correlating to one column of output that is yield measured in pounds. Generate the code that will use pandas to validate the data in this table before building and training a Random Forest machine learning model for predicting yield.”

Based on this prompt, the GPT can generate code that can perform the data wrangling in data wrangling engine 312, such as the following code in Algorithm 1:

Algorithm 1: Example code generated by GPT to perform data wrangling

import pandas as pd
from sklearn.model_selection import train_test_split
from sklearn.ensemble import RandomForestRegressor
from sklearn.metrics import mean_squared_error
import numpy as np
# Load the dataset
df = pd.read_csv(‘cropyields.csv’)
# Validate and inspect the data
# Check for missing values
print(“Missing values in each column: \n”, df.isnull( ).sum( ))
# Check for any duplicate rows
print(“Duplicate rows: ”, df.duplicated( ).sum( ))
# Check the data types for each column
print(“Data types: \n”, df.dtypes)
# Assuming ‘yield’ is the name of the output column. Replace ‘yield’ with the actual name if
different.
# Also, make sure all your input columns are numeric for the Random Forest model.
# You might need to convert categorical variables using methods like one-hot encoding.
# Optional: Fill missing values if any, here we're simply dropping them for simplicity
df.dropna(inplace=True)
# Split the data into inputs and output
X = df.drop(‘yield’, axis=1) # Replace ‘yield’ with your actual yield column name
y = df[‘yield’] # Replace ‘yield’ with your actual yield column name
# Split the dataset into training and test sets
X_train, X_test, y_train, y_test = train_test_split(X, y, test_size=0.2, random_state=42)
# Initialize and train the Random Forest model
rf = RandomForestRegressor(n_estimators=100, random_state=42)
rf.fit(X_train, y_train)
# Predictions and model evaluation
y_pred = rf.predict(X_test)
mse = mean_squared_error(y_test, y_pred)
rmse = np.sqrt(mse)
print(“RMSE: ”, rmse)
# Feature Importance - Understanding which features contribute most to the model
prediction
feature_importances = pd.Series(rf.feature_importances_.
index=X.columns).sort_values(ascending=False)
print(“Feature Importances:\n”, feature_importances)

In many embodiments, analytics engine 313 can perform multiple forms of machine learning and statistical data analytics against the data queried by query engine 311 and wrangled by data wrangling engine 312, to generate multiple potential solution sets representing combinations of PLC set points and/or process inputs. In some embodiments, each of the multiple potential solution sets can specify a respective potential combination of PLC set points and process inputs. In several embodiments, the multiple machine-learning models can include one or more of a design of experiments statistical analysis model, a Bayesian optimization model, a Gaussian regression, a random forest model, a gradient boosting model, a multi-armed bandit analysis model, SVM (Support Vector Machine) algorithms, Naïve Bayes algorithms, KNN (K Nearest Neighbors) algorithms, K-means algorithms, dimensionality reduction algorithms, and/or any suitable model for the analysis. Using different models can beneficially return different results. For example, a Gaussian regression analysis and a Bayesian optimization performed against the same data set can return different analytical results, which can be further assessed to speed the optimization of any automated setting.

In some embodiments, analytics engine 313 can use Python machine learning packages, Matlab, r, PRISM, MCMC (Markov chain Monte Carlo), and/or other suitable machine learning models. The machine learning approaches can include Gaussian Regression, Gradient Boosting, Random Forest Models, Bayesian Optimization, Design of Experiments (DOE) statistical analysis models, a multi-armed bandit analysis model, SVM algorithm, Naive Bayes algorithm, KNN algorithm, K-means, Dimensionality reduction algorithms, and/or other suitable models. Analytics engine 313 can be open to using any packaged or custom model. These models can be custom-written or generated with an LLM (e.g., 332), which can accelerate the work and lower the cost. The plug-and-play flexibility for query types and ML model types can be advantageous for the further processing to speed the optimization of any automated environment, as described below.

For example, in a greenhouse environment the multiple potential solution sets can suggest combinations of inputs that can be used to increase crop yield. These inputs can include target environmental conditions (e.g., temperature, humidity, light levels, soil moisture, etc.), soil chemistry (e.g., nitrogen, phosphorus, potassium, calcium, magnesium, organic matter content, pH, etc.), machine settings (seeder depth, shade curtains, robotic gantry speed, venting, etc.), and/or other suitable inputs. In other examples, such as a power plant, power plant PLC settings can be tuned for optimizing fuel efficiency and/or stack emissions. In some embodiments, the multiple potential solution sets can be stored in a solutions repository. For example, the multiple potential solution sets can be stored in a structured table, such as Google Sheets, .csv files, SQL data bases, and/or another suitable data repository.

In many embodiments, assessment engine 314 can assess the multiple potential solution sets generated by analytics engine 313 to select one or more solution sets. Generating multiple probabilistic recommendations from multiple machine learning models is advantageous because no single query, single type of ML model, or single set of ML model parameters will adequately solve (e.g., optimize) for every optimization problem. There are as many combinations of system input parameters as there are ways to query and analyze the data. Using multiple methods and comparing the outputs shows that, for some input parameters, solutions from the models will converge on optimum set points and inputs, while for others, they will diverge. Testing these divergent possibilities is beneficial for finding the probabilistic model that works the best for any one location, system, device, process, or problem.

The following is a Random Forest ML model recommendation for increasing microgreen yields by tuning the 9 variables determined to have the highest influence over yield in this particular data set.
Number of Seeds: ˜4,005,794
Seed Depth: ˜0.33 inches
Soil pH: ˜6.04
Soil Nitrogen (N): ˜240 ppm
Soil Phosphorus (P): ˜65 ppm
Soil Potassium (K): ˜602 ppm
Soil Organic Matter (OM) %: ˜9.13%
Soil Magnesium (Mg): ˜436 ppm
Soil Calcium (Ca): ˜1,743 ppm

Every time a model is run, the answer/recommendation in the proposed solution set can be different. When solutions from multiple models converge on an answer, such as using 4 million seeds, then this answer has a high probability for success (e.g., convergence). Conversely multiple model outputs can give a wide range of recommendations for levels of calcium and magnesium combinations (e.g., divergence). Testing across the divergence range offers opportunities for additional testing, potential yield increases, and the model to learn. When testing across divergent levels of recommended inputs, there can be a benefit in various ways, such as learning which models and models parameters best predict the optimization, and/or finding gains with regard to system performance of a particular system.

Such divergence typically points to local maximum and/or minimum solutions vs. global maximum and/or minimum solutions in the solutions space for a complex system. Testing divergent values can afford for better training of future models and a higher likelihood of finding global maximum and/or minimum solutions in a given solution space. No one model or set of model parameters finds the optimization for any one system power plant or greenhouse, or any one situation, different power plant fuel or different crop type. There is significant value with accelerated learning and optimization in this step.

The multiple potential solution sets can include versions of set point data and process inputs for testing. Testing of multiple potential solutions of recommended optimal set points derived from multiple queries and multiples forms of analyses can inform which data queries and forms of analytics are more suitable for a specific facility process. Alternatively stated, different queries and different analytical approaches can be more effective for different facilities.

In many embodiments, solutions engine 315 can store and/or output the one or more solution sets selected by assessment engine 314. For example, these set points and process inputs can be stored in tabular form in a table (e.g., csv file, SQL database, etc.). In many embodiments, these solution sets can be set points or process inputs to be used for operational testing of plant 320. These set points can be output to edge system 324 and/or PLCs 323, as an alternative to a human accessing the HMI or workstation to update set points. Such table of set points, after established, can be updated automatically via scripts that update control system data blocks or other files that store PLC set points. In many embodiments, the process performed by engines 311-315 can iterate, to test and refine new set points. These techniques can minimize or eliminate human interaction with control systems (e.g., via HMI and/or workstation systems), which can reduce human labor and error and can optimize system inputs and outputs with machine learning processes that interact with the physical plant in place of humans. Yet such elimination reduction or elimination of the HMI interface is not mere automation of what humans were already doing, but involves significant performance improvements over conventional approaches, based on querying multiple forms of data, generating multiple potential solution sets using multiple machine-learning models, analyzing such potential solution sets for convergence and divergence to select solution sets for testing, and performing iterative testing on solution sets to final local and global optimums.

In various embodiments, solution sets can be stored in a set point repository, which can be automatically updated over time during a continuous process or updated at the start of a batch process. Once established, this table of set point and process input solution sets can contribute to a history of how various combinations of inputs drive system performance for measurable outputs for iterative machine learning. In some embodiments, this information can be stored in data historian 326, and it can be analyzed with other data using multiple approaches to data analytics to predict how combinations of inputs result in target outputs. The higher number of examples that a plant (e.g., 320) or user (e.g., 331) stores, the more valid are the various data analytical approaches for predicting outcomes based on specific combination of PLC set points and process inputs. Repeatedly engaging in the process of tracking results and analyzing inputs to outputs creates a machine learning or artificially intelligent system that can automatically and physically tune PLC performance without a human engaging with the PLC via the HMI or a computer workstation to operate the plant.

These techniques represent a significant improvement to how control systems are monitored and managed to improve plant performance in facilities controlled by PLCs (e.g., 323). Many systems controlled by PLCs are complex, and it is difficult, expensive, and time consuming to test every possible combination of set points and process inputs. Such system set points as inputs often do not generate linear responses in outputs. The inputs have secondary, tertiary and higher order interacting effects. Some analyses of these inputs can result in finding local vs. global or optimized maximum and minimum solutions. It is most often not possible to determine the relationships of these inputs to each other or optimal solutions of combinations of these inputs without the use of advanced data analytics, such as using the techniques described herein. Such advanced data analytics can be enhanced when inputs are tested automatically, systematically, and in small increments across a wide range of potential combinations, such as by AI control system 310 described herein. Solutions optimizing inputs to improve facility output to achieve mere single-digit percentage points for process improvement can often be worth millions of dollars annually to facility owners.

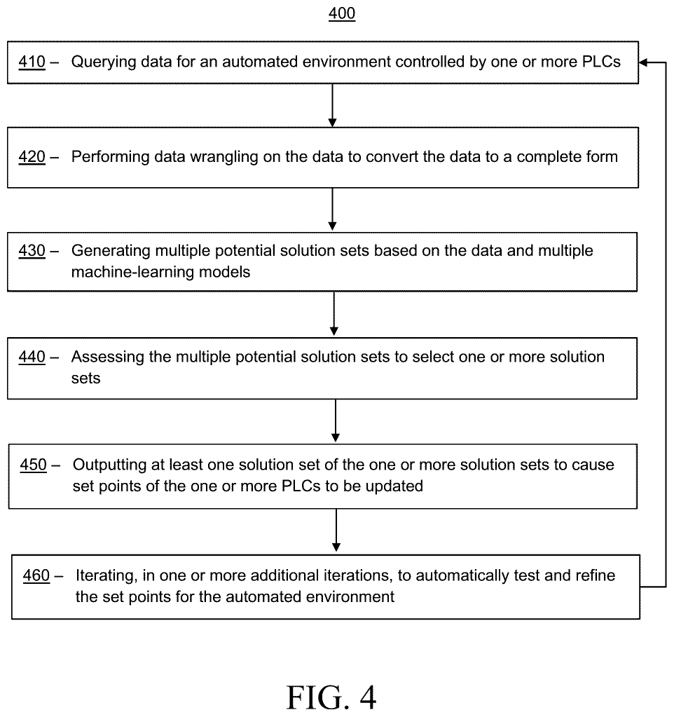

Turning ahead in the drawings, FIG. 4 illustrates a flow chart for a method 400 of implementing an artificially intelligent control system agent, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) and/or AI control system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1). In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include an activity 410 of querying, from a data historian associated with one or more programmable logic controllers (PLCs) and/or an enterprise/market data store, data for an automated environment controlled by the one or more PLCs. In some embodiments, activity 410 can be similar or identical to those activities described above in association with query engine 311 (FIG. 3). The data historian can be similar or identical to data historian 326 (FIG. 3). The enterprise/market data store can be similar or identical to enterprise/market data store 325 (FIG. 3). The PLCs can be similar or identical to PLCs 323 (FIG. 3). The automated environment can be similar or identical to automated environment 321 (FIG. 3) of plant 320 (FIG. 3). For example, the automated environment can be a power plant, a chemical plant, a greenhouse, a manufacturing plant, a water treatment plant, or another suitable type of plant. In a number of embodiments, activity 410 can be performed by query engine 311 (FIG. 3).

In some embodiments, the data can include (i) initial process set points of the one or more PLCs for controlling the automated environment, such as the set points at the time of the query or historically, before the set points are updated by AI control system 310 in this iteration of method 400, (ii) sensor data from the automated environment, (iii) result data associated with the automated environment, and/or other suitable data. For example, when the automated environment is a greenhouse, the result data can be environmental conditions resulting in crop yields.

In some embodiments, activity 410 of querying, from data can include using multiple forms or queries to generate multiple formats of data from multiple sources including a data historian associated with performance of an automated environment controlled by one or more programmable logic controllers (PLCs), data for the automated environment controlled by the one or more PLCs, and/or data from a corporate data store or internet source. In some embodiments, the multiple forms of queries can include one or more of real-time, hourly averages, multiple hour averages, daily averages, batch process, and/or another suitable forms of data. In some embodiments, the multiple forms of queries can be generated using a large language model, such as described above. The data sources can include the data historian (e.g., 326 (FIG. 3)), an enterprise/market data store (e.g., 325 (FIG. 3)), and/or other data sources. For example, the data sources can be logging from the automated environment, such as an automated process or facility or from an internet source.

In a number of embodiments, method 400 also can include an activity 420 of performing data wrangling on the data to validate the data and/or convert the data to a complete form. In some embodiments, activity 420 can be similar or identical to those activities described above in association with data wrangling engine 312 (FIG. 313). In some embodiments, activity 420 can be performed by data wrangling engine 312 (FIG. 3). In some embodiments, activity 420 of performing the data wrangling can include correcting data formats of the data. In some embodiments, activity 420 of performing the data wrangling can include filling in one or more missing portions of the data by extrapolating a time-series data function, as described above. In some embodiments, activity 420 of performing the data wrangling can include filling in a null cell of the data using a value calculated from a column of the data corresponding with the null cell. For example, a mean, median, mode, etc., of the column can be used for the null cell. In some embodiments, the data wrangling is performed at least in part using a large language model, such as described above.

In a number of embodiments, method 400 additionally can include an activity 430 of generating multiple potential solution sets based on analyzing the data with multiple machine-learning models. In some embodiments, activity 430 can be similar or identical to those activities described above in association with analytics engine 313 (FIG. 3). In many embodiments, each of the multiple potential solution sets can specify a respective potential combination of PLC set points and process inputs. In some embodiments, the multiple machine-learning models can be one or more of a design of experiments statistical analysis model, such as a Bayesian optimization model, a Gaussian regression, a random forest model, a gradient boosting model, a multi-armed bandit analysis model, or any other suitable models, such as those listed above. In some embodiments, one or more of the multiple machine-learning models can be generated and trained using a large language model, such as described above. In some embodiments, activity 430 can be performed by analytics engine 313 (FIG. 3).

In a number of embodiments, method 400 further can include an activity 440 of assessing the multiple potential solution sets to select one or more solution sets. In some embodiments, activity 440 can be similar or identical to those activities described above in association with assessment engine 314 (FIG. 3). In some embodiments, activity 440 of assessing the multiple potential solution sets to select the one or more solution sets can include evaluating convergence levels of outputs of the multiple potential solution sets and/or evaluating divergence levels of outputs of the multiple potential solution sets. For example, if some of the solutions convergence within a threshold (e.g., predetermined or configurable threshold), solutions for those models can be selected as the one or more solution sets, while solutions that diverge are used for comparative testing. In some embodiments, activity 440 can be performed by assessment engine 314 (FIG. 3).

In a number of embodiments, method 400 additionally can include an activity 450 of outputting at least one solution set of the one or more solution sets to cause (i) set points of the one or more PLCs to be automatically updated based at least in part on the at least one solution set, and (ii) physical devices of the automated environment controlled by the one or more PLCs to alter behavior of the automated environment. In some embodiments, activity 450 can be similar or identical to those activities described above in association with solutions engine 315 (FIG. 3). For example, the solution sets can be stored and output to edge systems (e.g., 324 (FIG. 3)) to update the set points in the one or more PLCs (e.g., 323 (FIG. 3)). In some embodiments, activity 450 can be performed by solutions engine 315 (FIG. 3). Updating the set points can cause physical devices in the automated environment, such as switches, relays, motor controllers, etc., to change function and alter the physical behavior of an automated environment (e.g., automated facility or factory).

In a number of embodiments, method 400 further can include an activity 460 of iterating through activities 410-440, in one or more additional iterations, based on the set points of the one or more PLCs being updated each iteration, to automatically test and refine the set points for the automated environment.

To illustrate example, method 400 can be implemented in associated with a greenhouse automated with a PLC (e.g., 323 (FIG. 3)). The greenhouse grows plants with inputs to soil, environmental control and machine control. The greenhouse performance yield is tracked with each harvest along with system set points and the performance of greenhouse machines and environmental controls in the data historian (e.g., 326 (FIG. 3)). An AI control system (e.g., 310 (FIG. 3)) queries the data from the data historian and other sources into multiple formats, runs multiple forms of analytics against multiple queries to generate multiple potential solution sets, selects solution sets, and multiple sets of setpoints and process inputs are communicated to the PLC for testing. The process of iteratively operating the facility with new set points continues in a loop for continuous plant improvement by the AI control system (e.g., 310 (FIG. 3)).

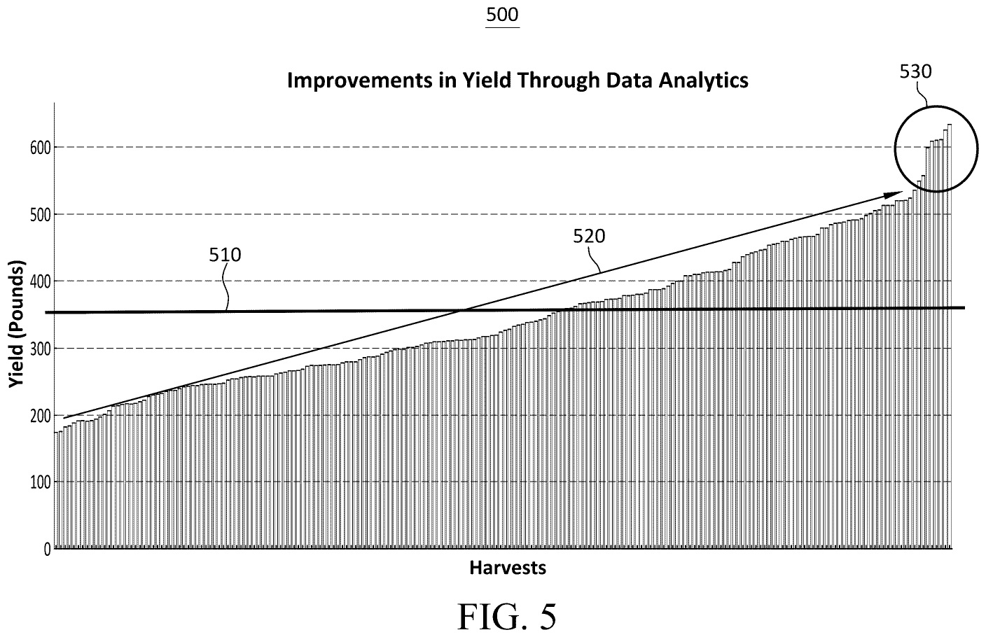

The AI control system (e.g., 310 (FIG. 3)) advantageously provides a significant improvement in the ability to operate physical plants, as it can determine optimized combinations of operational parameters as determined by PLC set points and system inputs that cannot be determined by human observation, trial and error, and manual adjustments in any reasonable amount of time or with predictable results. Such AI control system is highly valuable for minimizing plant inputs, maximizing plant outputs, optimizing plant performance, and minimizing human labor and human error in operating a physical plant. For example, FIG. 5 illustrates a graph showing improvements in yield for microgreens in an automated greenhouse through the application of data analytics. The graph shows the yield in pounds plotted for each of the harvests. Line 510 shows a baseline yield that generates a 30% un-levered IRR (internal rate of return). Line 520 shows significant gains in yields that have been achieved using data analytics with the AI control system (e.g., 310 (FIG. 3)), using the techniques described herein, such as increasing yields from below 250 pounds per harvest to more than 600 pounds per harvest. Area 530 emphasizes recent gains in yields (i.e., 28%), achieved using the AI control system (e.g., 310 (FIG. 3)).

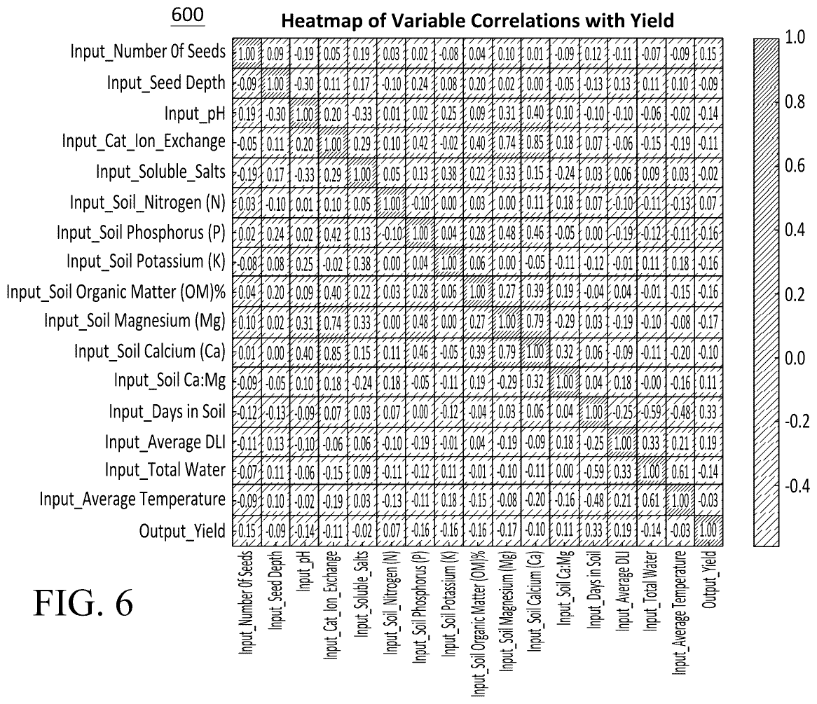

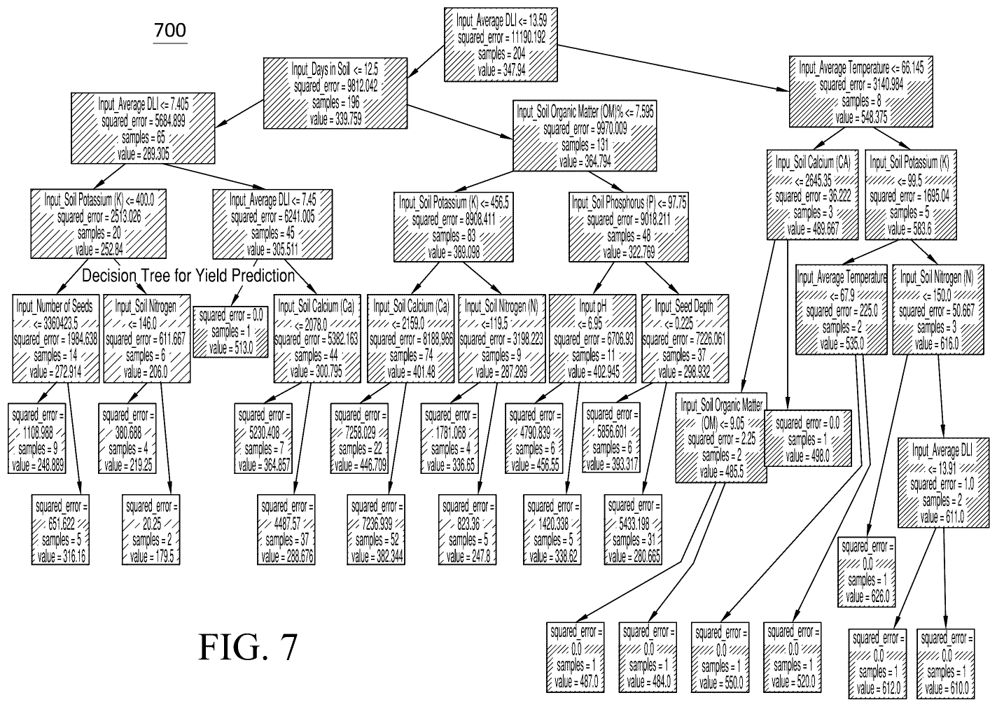

The AI control system (e.g., 310 (FIG. 3)) can obtain information from many different sensors and sources in activity 410 (FIG. 4). For example, the input data can include the number of seeds, seed depth, pH, Cat Ion exchange, soluble salts, soil nitrogen, soil phosphorus, soil potassium, soil organic matter, soil magnesium, soil calcium, soil calcium-to-magnesium ratio, days in soil, average DLI (daily light integral), total water, average temperature. In a number of embodiments, the results (output) can be crop yield data. FIG. 6 illustrates a heatmap 600 of variable correlations with yield from analysis by a statistical model applied against this data in an activity 430 (FIG. 4), where each cell represents the strength of the relationship between two variables, as indicated by the scale. Activity 430 also can involve using a decision tree machine learning model, for example. FIG. 7 shows an example of a decision tree 700 for yield prediction using this greenhouse data, to determine which input levels optimize the yield in this environment. The tree structure starts with a root node at the top, branching out into subsequent levels of decision nodes and leaf nodes, each representing a decision rule or outcome based on the input data.

Using a random sampling approach within the specified ranges, the highest predicted yield achievable is approximately 967.25 pounds. This prediction is based a Random Forest ML model recommendation for increasing microgreen yields by tuning the 9 variables determined to have the highest influence over yield in this particular data set. The prediction uses the following combination of inputs, within 10% of the range of values in the dataset:
Number of Seeds: ˜4,005,794
Seed Depth: ˜0.33 inches
Soil pH: ˜6.04
Soil Nitrogen (N): ˜240 ppm
Soil Phosphorus (P): ˜65 ppm
Soil Potassium (K): ˜602 ppm
Soil Organic Matter (OM) %: ˜9.13%
Soil Magnesium (Mg): ˜436 ppm
Soil Calcium (Ca): ˜1,743 ppm

This result provides an estimation of the input combination that could lead to optimal crop yield under the given constraints. The same approach can be used to predict the optimal combination of inputs in any facility, such as a powerplant, water treatment plant, chemical manufacturing plant, or bottling plant to maximize and/or minimize any measurable outcome in the operation of a physical facility.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although the artificially intelligent control system agent has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the systems and/or engines within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
querying, from data sources comprising a data historian associated with performance of an automated environment controlled by one or more programmable logic controllers (PLCs), data for the automated environment controlled by the one or more PLCs;
generating multiple potential solution sets for PLC settings and process inputs based on the data and multiple machine-learning models;
assessing the multiple potential solution sets to select one or more solution sets; and
outputting at least one solution set of the one or more solution sets to cause (i) set points of the one or more PLCs to be automatically updated based at least in part on the at least one solution set, and (ii) physical devices of the automated environment controlled by the one or more PLCs to alter behavior of the automated environment.

2. The computer-implemented method of claim 1 further comprising:
iterating through querying the data, generating the multiple potential solution sets, assessing the multiple potential solution sets, and outputting the at least one solution set, in one or more additional iterations, based on the set points of the one or more PLCs being updated each iteration, to automatically test and refine the set points and the process inputs for the automated environment.

3. The computer-implemented method of claim 1, wherein the data comprises:
initial set points and process inputs of the one or more PLCs for controlling the automated environment;
sensor data from the automated environment; and
result data associated with the automated environment.

4. The computer-implemented method of claim 3, wherein:
the automated environment is one of a greenhouse, powerplant, water treatment plant, or manufacturing facility; and
the result data comprises performance of the automated environment.

5. The computer-implemented method of claim 1, wherein querying the data further comprises:
querying the data using multiple forms of queries to generate multiple formats of the data.

6. The computer-implemented method of claim 5, wherein the multiple forms of queries comprise one or more of real-time, hourly averages, multiple hour averages, daily averages, or batch process.

7. The computer-implemented method of claim 5, wherein the multiple forms of queries are generated using a large language model.

8. The computer-implemented method of claim 1 further comprising, after querying the data:
performing data wrangling on the data to convert the data to a complete form.

9. The computer-implemented method of claim 8, wherein performing the data wrangling comprises:
correcting data formats of the data.

10. The computer-implemented method of claim 8, wherein performing the data wrangling comprises:
filling in one or more missing portions of the data by extrapolating a time-series data function.

11. The computer-implemented method of claim 8, wherein performing the data wrangling comprises:
filling in a null cell of the data using a value calculated from a column of the data corresponding with the null cell.

12. The computer-implemented method of claim 8, wherein the data wrangling is performed at least in part using a large language model.

13. The computer-implemented method of claim 1, wherein each of the multiple potential solution sets specify a respective potential combination of PLC set points.

14. The computer-implemented method of claim 1, wherein the multiple machine-learning models comprise one or more of a design of experiments statistical analysis model, a Bayesian optimization model, a Gaussian regression, a random forest model, a gradient boosting model, or a multi-armed bandit analysis model, a SVM algorithm, a Naive Bayes algorithm, a KNN algorithm, a K-means algorithm, or a dimensionality reduction algorithm.

15. The computer-implemented method of claim 1, wherein one or more of the multiple machine-learning models is generated and trained using a large language model.

16. The computer-implemented method of claim 1, wherein assessing the multiple potential solution sets to select the one or more solution sets further comprises:
evaluating convergence levels of outputs of the multiple potential solution sets.

17. The computer-implemented method of claim 16, wherein assessing the multiple potential solution sets to select the one or more solution sets further comprises:
evaluating divergence levels of outputs of the multiple potential solution sets.

18. The computer-implemented method of claim 1, wherein the automated environment comprises one of a power plant, a chemical plant, a greenhouse, a manufacturing plant, or a water treatment plant.

19. A system comprising one or more processors and one or more non-transitory computer-readable media storing computing instructions that, when executed on the one or more processors, cause the one or more processors to perform operations comprising:
querying, from data sources comprising a data historian associated with performance of an automated environment controlled by one or more programmable logic controllers (PLCs), data for the automated environment controlled by the one or more PLCs;
generating multiple potential solution sets for PLC settings and process inputs based on the data and multiple machine-learning models;
assessing the multiple potential solution sets to select one or more solution sets; and
outputting at least one solution set of the one or more solution sets to cause (i) set points of the one or more PLCs to be automatically updated based at least in part on the at least one solution set, and (ii) physical devices of the automated environment controlled by the one or more PLCs to alter behavior of the automated environment.

20. One or more non-transitory computer-readable media comprising computing instructions that, when executed on one or more processors, cause the one or more processors to perform operations comprising:
querying, from data sources comprising a data historian associated with performance of an automated environment controlled by one or more programmable logic controllers (PLCs), data for the automated environment controlled by the one or more PLCs;
generating multiple potential solution sets for PLC settings and process inputs based on the data and multiple machine-learning models;
assessing the multiple potential solution sets to select one or more solution sets; and
outputting at least one solution set of the one or more solution sets to cause (i) set points of the one or more PLCs to be automatically updated based at least in part on the at least one solution set, and (ii) physical devices of the automated environment controlled by the one or more PLCs to alter behavior of the automated environment.
